(19) United States
(12) Patent Application Publication
(10) Pub. No.: US 2010/0083803 A1
(43) Pub. Date: Apr. 8, 2010

(54) Perforating Apparatus

(76) Inventor: Ronald Malcolm Bond Sanderson, Lower Hutt (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/570,408

(22) Filed: Sep. 30, 2009

Related U.S. Application Data
(60) Provisional application No. 61/102,518, filed on Oct. 3, 2008.

(51) Int. Cl. B26D 5/00; B26D 7/02; B26D 1/06

(52) U.S. Cl. 83/36; 83/375; 83/76.1

(57) ABSTRACT

A perforation apparatus has a mandrel to support at least a part of the piping that is to be perforated from the interior of the piping. A punch housing has an aperture through which the piping is moveable and punches arranged radially around the aperture. At least some of the punches have an associated clamping mechanism that applies a force to the exterior of the piping adjacent the respective punch, to push or hold the piping against the mandrel. A driven annular housing rotates adjacent the punch housing. A plurality of rollers engage a surface on the punches during rotation of the annular housing to operate the punches upon contact and to operate the clamping mechanisms. A punch retracting mechanism retracts the punches after each operation. At least one mechanism longitudinally and rotationally moves the piping relative to the punch housing and drives the annular housing.

### FIELD OF INVENTION

The invention comprises an apparatus for perforating piping, tubing or the like.

### BACKGROUND

A variety of apparatuses for perforating by cold stamping materials such as metal or plastics piping are known. Typically these utilise a reciprocating punch wherein after one perforation has been formed the punch retracts allowing the work material to be re-orientated or further fed through the apparatus. The punch is typically retracted using spring release mechanisms which are prone to jamming and limit the speed of operation of the punch. A further disadvantage of those apparatuses is that they are restricted to a single pattern of perforations.

An apparatus for forming a baffle is disclosed in my PCT publication number WO 03/039781 published 15 May 2003. That apparatus has a punch housing with punches, a driven annular housing, and rollers that rotate around the punch housing as the annular housing is driven, to cause the punches to perforate the piping. A chuck carries the piping, and a mandrel is positioned within the piping. Applicant has found that with that apparatus, the piping is prone to deflecting as the punches undergo the perforating steps, which can possibly cause wear of the punch members or mandrel.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

It is an object of at least preferred embodiments of the present invention to provide a perforating apparatus that addresses that issue, or that at least provides the public with a useful alternative.

### SUMMARY OF INVENTION

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

In accordance with an aspect of the present invention, there is provided a perforation apparatus suitable for perforating tubing or piping comprising:
a mandrel adapted to support at least a part of the piping that is to be perforated, wherein the mandrel is adapted to support the piping from the interior of the piping;
a punch housing comprising an aperture through which the piping is longitudinally and rotationally moveable and a plurality of punches arranged radially around the aperture and operable to perforate the piping passing through the punch housing, with the punches adapted to perforate the piping by passing from an exterior of the piping to an interior of the piping, wherein at least some of the punches have an associated clamping mechanism that is adapted to apply a force to the exterior of the piping adjacent the respective punch during least a major part of the duration of a perforating step by that punch, to push or hold the piping against the mandrel;
a driven annular housing comprising an aperture corresponding to the punch housing aperture and arranged to rotate adjacent the punch housing, a plurality of rollers arranged to rotate in an annular path around the punch housing upon rotation of the annular housing and arranged to engage a surface on the punches during rotation of the annular housing to operate the punches upon contact and to operate the clamping mechanisms, and a punch retracting mechanism arranged to retract the punches after each operation; and
at least one mechanism to longitudinally and rotationally move the piping relative to the punch housing and to drive the annular housing.

Preferably, the apparatus is configured such that the clamping mechanisms are operated by the rollers to apply force to the exterior of the piping as or before the respective punch begins a perforating step and to release force from the exterior of the piping as or after the respective punch completes its perforating step, so that the force is applied by the respective clamping mechanism throughout the duration of the perforating step by the respective punch. Preferably, the apparatus is configured such that the clamping mechanisms are operated by the rollers to apply force to the exterior of the piping before the respective punch begins a perforating step and to release force from the exterior of the piping after the respective punch completes its perforating step, so that force is applied by the respective clamping mechanism for longer than the duration of the perforating step by the respective punch. Preferably, the clamping mechanisms each comprise an engagement surface and the punches each comprise an engagement surface, wherein the clamping mechanism engagement surfaces are engaged by the rollers to cause the clamping mechanisms to apply force to the exterior of the piping prior to the rollers engaging the respective punch engagement surfaces to operate the respective punches, and wherein the clamping mechanism engagement surfaces are disengaged by the rollers to cause the clamping mechanisms to release force from the exterior of the piping after the rollers disengage the respective punch engagement surfaces to cease operating the respective punches. Preferably, each clamping mechanism engagement surface comprises an angled leading surface, wherein an initial portion of the angled leading surface that is initially engaged by a roller is positioned at a first radial distance from the aperture of the punch housing, and a trailing portion of the initial angled leading surface that is subsequently engaged by the roller is positioned at a second radial distance from the aperture of the punch housing, wherein the second radial distance is greater than the first radial distance to cause the clamping mechanism to gradually engage the piping.

Preferably, a plurality of pairs of adjacent rollers are rotatably mounted to the driven annular housing, and a respective auxiliary roller is captured between each pair of rollers and an annular surface on the punch housing, with the auxiliary rollers caused to move in an annular path around the annular surface of the punch housing to engage the clamping mechanisms and the punches. Preferably the rollers are substantially axially immovable relative to the driven housing.

Alternatively, the auxiliary rollers may not be provided, and rather than pairs of rollers being rotatably mounted to the driven housing, single rollers may be rotatably mounted to the driven housing and may engage the clamping mechanisms and the punches.

Preferably, the clamping mechanism engagement surfaces and the punch engagement surfaces at least partly project from the annular housing for engagement by the rollers.

Preferably, the punches each comprise a punch holder with a respective punch member. Preferably, the punch holders each comprise a main body portion that removably supports the punch members, and the main body portion defines a punch engagement surface which cooperates with the rollers to actuate the punch. Preferably, the punch holders each comprise a removable insert that is removably engaged with the main body portion, with the punch member receivable in the insert.

Preferably, each punch comprises an engagement surface that is angled such that a leading portion of the engagement surface that is initially engaged by a roller is positioned at a first radial distance from the aperture of the punch housing, and a trailing portion of the engagement surface that is subsequently engaged by a roller is positioned at a second radial distance from the aperture of the punch housing, wherein the second radial distance is greater than the first radial distance to cause the punch to gradually engage the piping during a perforating step.

Preferably, each punch has an associated clamping mechanism. Alternatively, some punches may have an associated clamping mechanism and some punches may not have an associated clamping mechanism.

Preferably, the apparatus comprises four punches with associated clamping mechanisms arranged radially around the aperture, wherein the clamping mechanisms of the four punches are configured to apply force to the piping concurrently. Preferably, said four punches with associated clamping mechanisms are arranged at a substantially even angular spacing around the aperture. Preferably, the apparatus may comprise more than four punches with associated clamping mechanisms arranged radially around the aperture.

Preferably, the punch housing comprises eight punches at about 45° angular spacing.

The apparatus preferably comprises a control system that is programmed or programmable with a selected arrangement or pattern of perforations and that is configured to control and coordinate the longitudinal and rotational movement of the piping through the punch housing with the operation of the clamping mechanisms and punches, to cause the apparatus to perforate a predetermined, selected part or parts of the piping, with the programmed, selected arrangement or pattern of perforations.

Preferably, the pattern that the control system is programmed or programmable with comprises at least one variation in perforation arrangement, and the control system is configured to cause the apparatus to perforate the piping with the programmed, selected arrangement or pattern of perforations, including said at least one variation in perforation arrangement.

Preferably, the control system is configured to control a punch actuation motor, a longitudinal piping movement motor and a rotational piping movement motor.

Preferably, the control system enables an operator to select from a preset perforation pattern, customise a unique pattern or instruct the system to calculate a pattern automatically.

Preferably, the control system enables an operator to select from a preset perforation pattern, and comprises a programmable logic controller (PLC).

Preferably, the mechanism to move the piping relative to the punch housing comprises a chuck arranged to selectively grip the piping.

Advantageously, the punch retracting mechanism includes a channel or recess around the annular housing which co-operates with a projection from the punches wherein the profile of the channel or recess is such that the punches are retracted after each operation. Alternatively, the punch retracting mechanism may include a punch retracting disk with an external profile which co-operates with a projection from the punches wherein the external profile of the punch retracting disk is such that the punches are retracted after each operation, and the punch retracting mechanism is formed integrally with or secured to the driven annular housing.

In one embodiment, rollers are axially secured to the annular housing, and the channel or recess around the annular housing or the external profile of the punch retracting disk is substantially circular in shape, but includes one or more regions of reduced radius or one or more dips radially aligned with the rollers.

The projection preferably includes at least one wheel or small roller which engages the punch retracting mechanism

The punch housing suitably includes a plurality of radial apertures for receipt of the punches.

The aperture of the punch housing through which piping is longitudinally and rotatably moveable advantageously includes a plurality of arcuate grooves to reduce friction on piping therein. Alternatively or in addition, the aperture of the punch housing through which piping is longitudinally and rotatably moveable may be flared to guide movement of piping therethrough.

The periphery of the driven annular housing suitably includes a plurality of teeth, such that rotation of the annular housing may be effected using a chain, toothed belt, or gears.

A mechanism to drive the piping moving mechanism is preferably configured to longitudinally and rotationally move the chuck. The mechanism to drive the piping moving mechanism may include independently actuable rotational and longitudinal drive motors, which are preferably electric servo motors.

The mandrel preferably includes an arbor and a die extending therefrom and configured to support the piping during punching. The die advantageously includes one or more radial apertures corresponding to the position of the punches.

In the embodiment including a plurality of apertures, the perimeter of the die advantageously includes semi-flat surfaces between the apertures to minimise friction on the inside of the piping.

Suitably, the arbor is held within a clamping block, and is selectively releasable therefrom so that the die is axially and rotatably moveable relative to the punches.

The die preferably includes a second set of apertures axially spaced from the first set of apertures.

The interior of the arbor is preferably separated by a dividing wall into a fluid inlet path and a fluid outlet path, with the fluid inlet path in fluid communication with a source of high pressure fluid to remove waste punching material from inside the die.

The fluid is preferably a coolant fluid.

A die clamping collar is preferably provided to attach the die to the arbor. Preferably, a keyway is present in the outer surface of the arbor and the inner surface of the die, and a key is located in the keyways to maintain alignment between the die and the arbor, the key being maintained in the keyways by the die clamping collar.

The punch housing suitably includes eight punches at about 45° angular spacing for example. The annular housing preferably includes four rollers at about 90° angular spacing, or may include eight rollers at about 45° angular spacing for example.

Preferably, the control system enables an operator to select from a preset perforation pattern, customise a unique pattern or instruct the system to calculate a pattern automatically. The control system advantageously enables a user to input a piping length, piping diameter, hole diameter, wall thickness dimensions, and the number and size of the perforation zone(s).

Suitably, the control system is operable to calculate a pattern automatically based on the actual surface area, percentage of piping surface area, or percentage of cross-sectional area of the piping.

The control system preferably includes a computer, a display and an input device to enable a user to input or select a desired arrangement or pattern of perforations. The computer is suitably loaded with a computer program which allows an operator to select a preset perforation pattern, customise a pattern, or instruct the program to calculate a perforation pattern according to parameters.

Alternatively, the control system may enable an operator to select from a preset perforation pattern, and includes a programmable logic controller (PLC).

According to a further aspect of the present invention, there is provided a method of perforating piping using an apparatus as outlined in relation to the first aspect above, the method comprising:
operating the clamping mechanisms to apply a force to the exterior of piping extending into or through the punch housing to push the piping against the mandrel;
operating the punches to perforate the piping; and
releasing the clamping mechanisms.

Preferably, the method further comprises following releasing the clamping mechanisms, longitudinally and/or rotationally moving the piping relative to the punch housing, and:
operating the clamping mechanisms to apply a force to the exterior of piping extending into or through the punch housing to push the piping against the mandrel;
operating the punches to perforate the piping; and
releasing the clamping mechanisms.

The invention consists in the foregoing and also envisages constructions of which the following gives examples only.

### BRIEF DESCRIPTION OF DRAWINGS

Preferred embodiments of the perforation apparatus of the present invention are described in detail with reference to the accompanying drawings, by way of example only and without intending to be limiting, in which:

FIG. 1 is an external view of a preferred embodiment perforating apparatus and control panel;

FIG. 2 is a partial section view of the apparatus along line AA;

FIG. 3a is an elevation view of the perforating mechanism on line BB of the apparatus;

FIG. 3b is a perspective view of the perforating mechanism of FIG. 3a;

FIG. 3c is a detail view of region C of FIG. 3a;

FIG. 4a is a part sectional view similar to FIG. 3a, showing the configuration of rollers, one punch member, and clamping mechanism prior to actuation of the punch and clamping mechanism by the rollers;

FIG. 4b is as detail view of the punch and clamping mechanism of FIG. 4a, showing their positioning relative to a piece of piping prior to actuation by the rollers;

FIG. 4c is a detail view of the relative positions of a roller and an engagement surface of the clamping mechanism prior to actuation by the roller; and

FIG. 4d is a perspective view of the components shown in FIG. 4c;

FIG. 5 is a view of a pipe perforated by the apparatus;

FIG. 6 shows a piping perforation pattern start-up screen;

FIG. 7 shows a completed piping perforation pattern screen;

FIG. 8 shows a new pipe dimensions popup screen; and

FIG. 9 shows a piping perforation pattern screen with a perforation location image.

FIG. 10 shows an edit zone popup screen;

FIG. 11 shows an add new set popup screen;

FIG. 12 shows an automatic pattern popup screen; and

FIG. 13 shows an automatically generated piping perforation pattern screen;

FIG. 14a shows an elevation view of an internal part of the punch housing;

FIG. 14b shows a sectional view of the internal part of the punch housing of FIG. 14a;

FIG. 14c shows a perspective sectional view of the internal part of the punch housing of FIG. 14a;

FIG. 15 shows a section view of the internal part of the punch housing of FIG. 14a;

FIG. 16a shows an elevation view of the annular housing for use with the punch housing of FIGS. 14 and 15;

FIG. 16b shows a perspective view of the annular housing of FIG. 16a;

FIG. 16c shows a detail view of detail C of FIG. 16b;

FIG. 17a is an exploded perspective view of a mandrel to support the piping during punching;

FIG. 17b is a detail view of region A of FIG. 17a;

FIG. 18 is a section view of the mandrel/die of FIG. 17a;

FIG. 19a is an elevation view similar to FIG. 3a, but showing the roller engaged with the clamping mechanism;

FIG. 19b is a detail view of region A of FIG. 19a;

FIG. 20a is an elevation view similar to FIG. 19a, but showing the roller engaged with the punch; and

FIG. 20b is a detail view of Figure A of FIG. 20a.

### DETAILED DESCRIPTION OF PREFERRED EMBODIMENTS

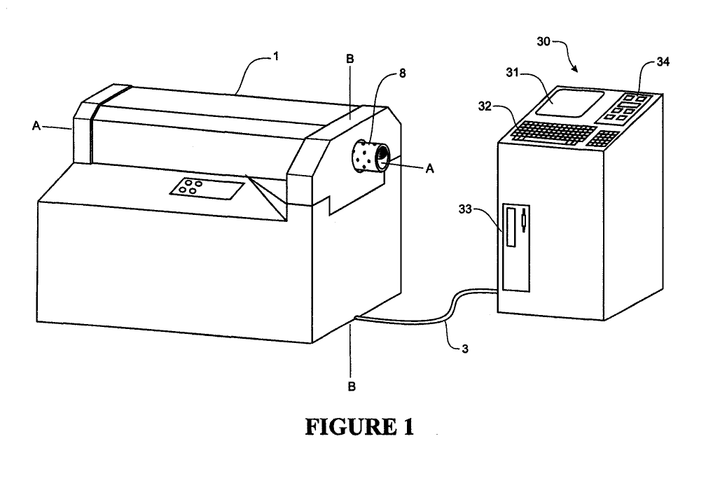

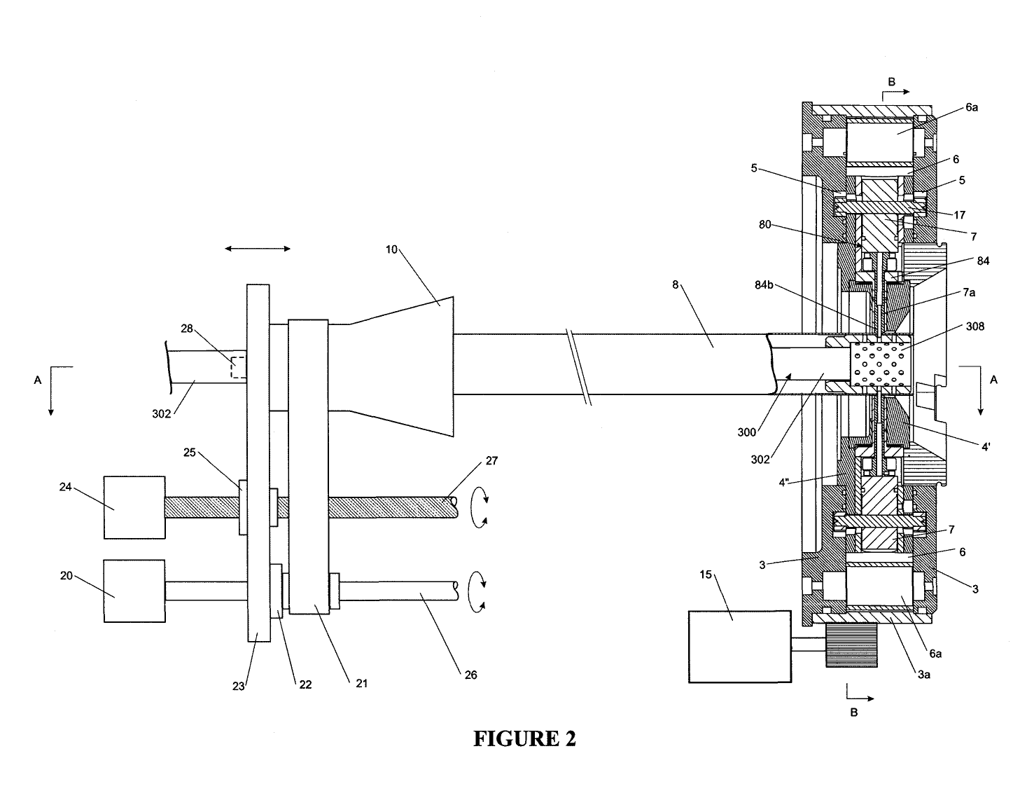

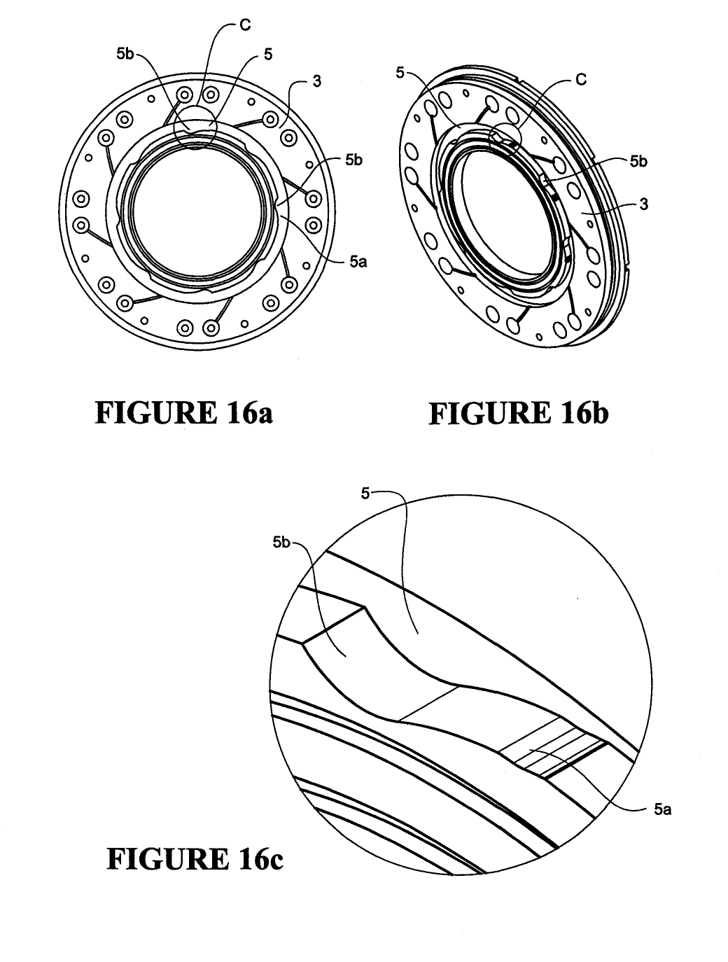

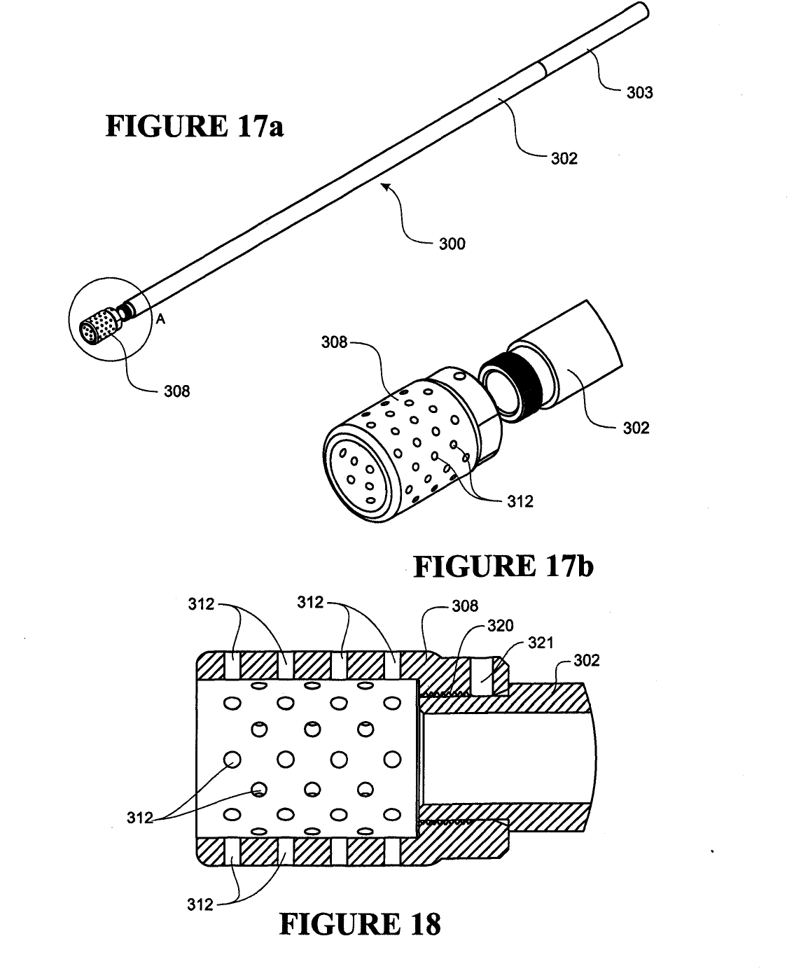

Referring to FIGS. 1 and 2, the preferred form perforating apparatus 1 includes a perforating mechanism 2 (on line BB) which is driven by a hydraulic motor 15, a chuck 10 which grips and moves a length of piping 8 rotationally and longitudinally (along line AA) through the perforating mechanism 2, and electric servo or stepping motors 20 and 24 which drive the chuck 10. The chuck also supports a mandrel 300 (shown in more detail in FIGS. 17 and 18) to support at least the part of the piping 8 to be punched from its interior. The mandrel stays in a stationary position relative to the punch housing 4 in use. The motors 15, 20 and 24 are controlled to co-ordinate the perforations performed by the perforating mechanism 2 with rotational and longitudinal movement of the piping 8 by the chuck 10 to allow predetermined perforation patterns to be carried out on the piping 8. The perforating mechanism 2 and chuck 10 may alternatively be driven by different combinations of pneumatic, hydraulic or electric motors, for example the motors 15, 20 and 24 may all be electric servomotors. The mechanism 2 and chuck 10 are preferably belt or chain driven 14 and 21 respectively, but other drive arrangements are possible. For example, the chuck 10 may be driven by a suitable gearbox arrangement from the mechanisms 2 motor 15.

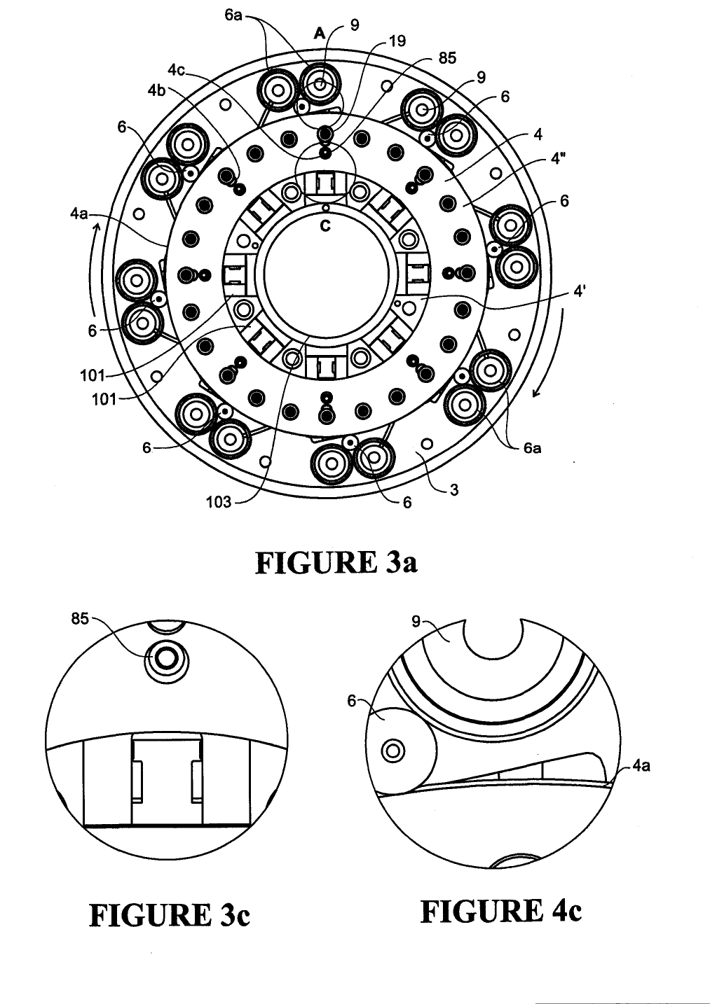

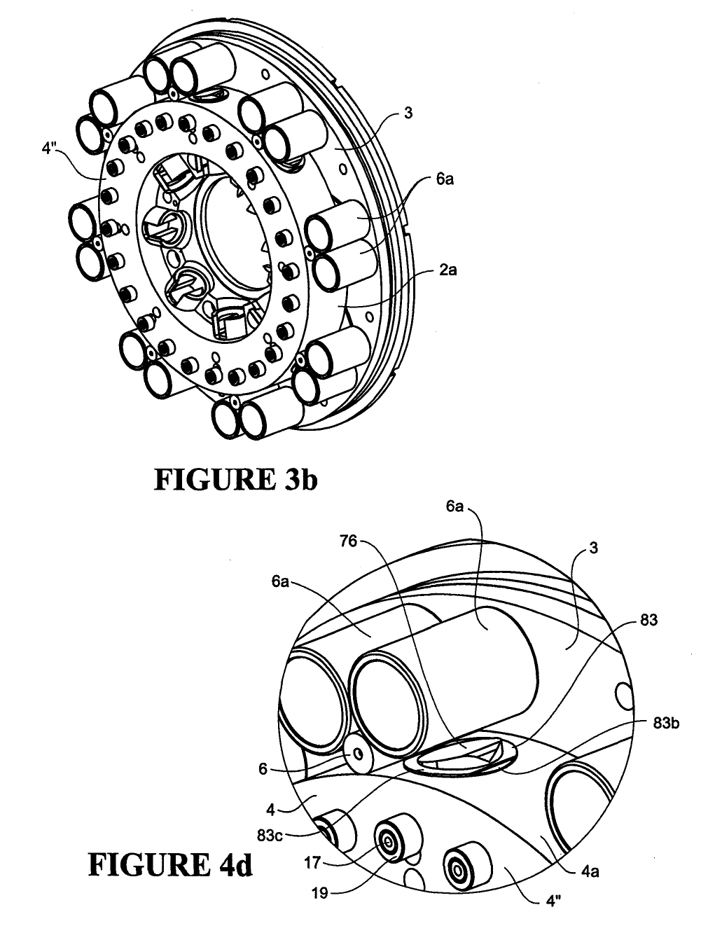

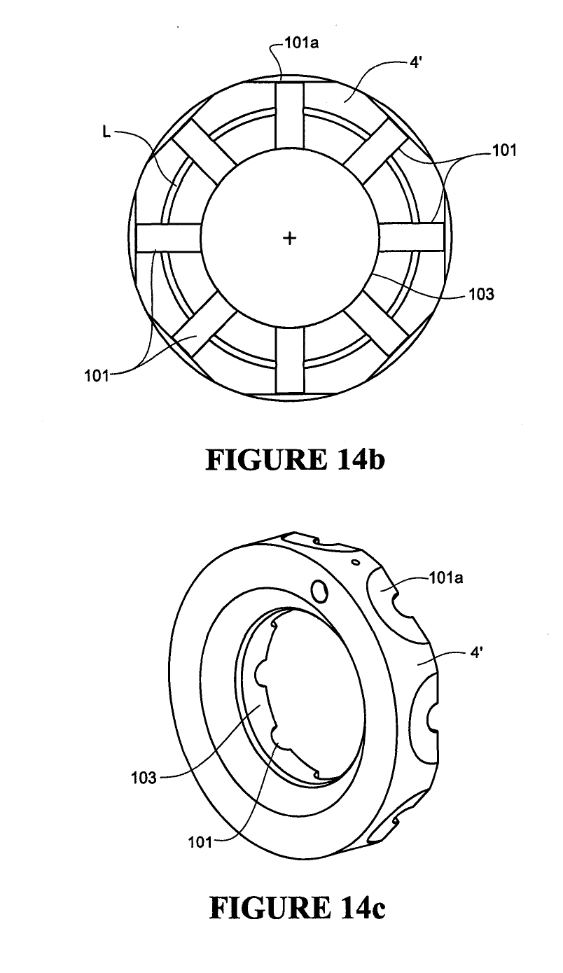

Referring to FIGS. 3a and 4a the perforating mechanism 2 comprises: a punch housing hub 4, eight punches 7, an annular housing 3 which includes punch retracting channel 5 (FIGS. 16a, 16b) and eight punch engaging rollers 6.

The annular housing 3 rotates about the hub 4 as shown by the direction arrows. A plurality of pairs, and in the embodiment shown eight pairs, of adjacent rollers 6a are rotatably mounted to the driven annular housing 3 on respective axles 9. A respective auxiliary roller 6 is captured between each pair of rollers 6a and an annular surface 4a on the punch housing hub 4, with the auxiliary rollers 6 caused to move in an annular path around the annular surface 4a of the punch housing to engage and operate the clamping mechanisms and the punches as will be described below. Preferably, the rollers 6a are axially secured to the annular housing, and the rollers 6 are axially constrained in their spacing between the rollers 6a and the annular surface. In the form shown, the pairs of rollers 6a are arranged at even 45° intervals around the housing 3. The rollers 6a and 6 are caused to rotate with the housing 3 such that rollers 6 roll around the outside of the hub 4. The rollers 6 engage or depress the punches 7 upon contact such that the engaged punches 7 perforate a corresponding section of piping 8. The punches 7 are arranged at 45° intervals around the hub 4, which ensures that eight punches 7 are engaged simultaneously by their rollers 6.

Different numbers of rollers and punches could be provided. By way of example only, four rollers 6 and eight punches 7 could be provided.

The periphery of the annular housing 3 is toothed, such that rotation of the annular housing may be effected using a chain, a toothed belt or gears. The preferred drive means for the annular housing is an electric servo motor.

Other arrangements of the rollers 6 and punches 7 are possible where the rollers 6 or punches 7 are separated by different angles, also different combinations of roller 6 and punch 7 numbers can be used.

Referring additionally to FIGS. 4b and 4d for example, the punches 7 each include a pin 17 which protrudes out of the hub 4 to interact with the retracting channels 5. Small wheels or rollers 19 are located at the ends of the pin 17 which roll around inside the channels 5. While not visible in the images, it will be appreciated that the reverse end of the pin will have a corresponding roller 19, and each roller 19 will travel inside a respective retracting channel. The retracting channels 5 rotate with the housing 3 and interact with the pins 17 such that the punches 7 are retracted from the piping 8 after contact with the rollers 6. As shown in FIG. 16, the channels 5 are substantially circular in shape, but include regions of reduced radius or dips 5a, 5b to allow the punches 7 in contact with the rollers 6 to be engaged into the piping 8. An initial part of the recess 5a has a relatively small depth, and corresponds to the initial depression of the clamping mechanism (described below) by the roller. A subsequent part of the recess 5b has a relatively large depth, and corresponds to the depression of the punch by the roller. As the housing 3 rotates, the rollers 6 roll past the punches 7 and the section of the channels 5 in contact with the pins 17 increases radius such that the punches 7 are retracted from the piping 8.

Alternatively a punch retracting cam(s) or disk(s) with an external profile equivalent to the channel 5 may be secured to or formed integrally with the flanged housing 3.

The punches 7 each comprise a punch member 7a that is easily removable from the hub 4 so that the punch members may be replaced with punch members 7a of different perforation face 7a′ size and/or shape. Different punch member 7 lengths may also be used to accommodate a range of piping 8 diameters. For piping 8 of substantially smaller diameter than the hub 4 internal cavity 11, a shroud (not shown) could be used to centre the piping 8. The shroud would include passages corresponding to the punches' 7 travel to the piping 8.

The housing 4 defines eight radial apertures 101 oriented at 45° angles within which eight punches are movably mounted.

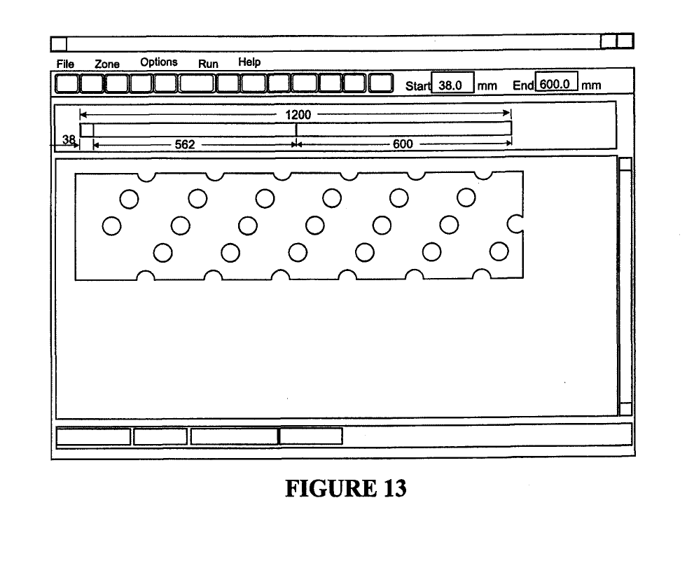

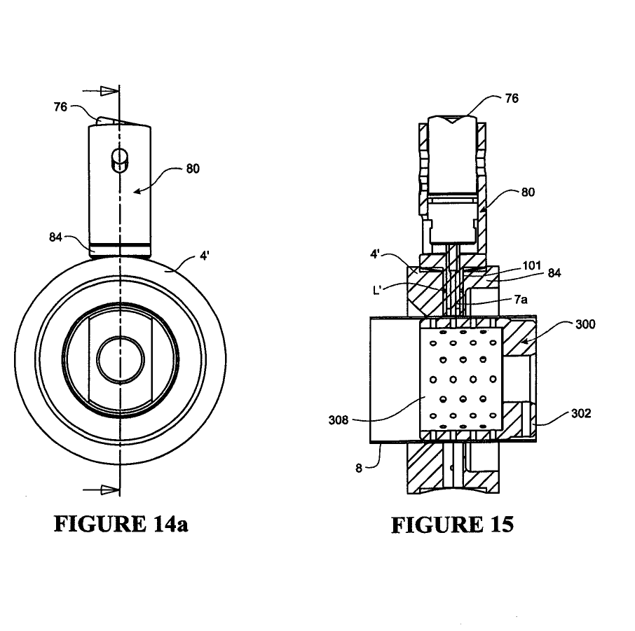

The punch housing 4 may be a one-piece item. However, in the preferred form, the punch housing preferably comprises an inner punch housing part 4′ and an outer punch housing part 4″. It will be appreciated that where reference is made herein to features or items of the punch housing, those may be features or items of the respective part of the punch housing in the case of a two- or multi-part punch housing. The inner punch housing part 4′ is shown in FIGS. 14a-15. The punch housing parts may be provided with lubrication features such as lubrication gallery L for lubricating moving components such as the punch holders. The lubrication may be delivered to the punch holders through apertures L′ in clamping portion 84.

Referring to FIG. 2, the chuck drive assembly comprises: the chuck 10, rotational and longitudinal drive motors 20 and 24 respectively, a carriage assembly 23, a pulley 22 mounted on a first shaft 26, a sleeve 25 mounted on a second shaft 27, a chuck axle 28 and a belt drive 21.

The chuck 10 is rotatably mounted on the chuck axle 28 which is secured to the carriage assembly 23. The sleeve 25 is secured to the carriage 23 such that as the second shaft 27 is rotated by the longitudinal drive motor 24, the sleeve 25 interacts with a thread or spiral grooves in the second shaft 27 such that it drives the carriage 23 and chuck 10 longitudinally. The pulley 22 is rotatably mounted to the carriage 23 and is longitudinally movable along the first shaft 26. As the first shaft 26 is rotated by the rotational drive motor 20, the pulley 22 drives the chuck 10 rotationally via the belt drive 21.

The apparatus 1 also includes a chuck 10 clamping and unclamping mechanism (not shown) which secures the piping 8 for perforation, and releases it upon completion.

Referring to FIGS. 2 and 3a, the hydraulic motor 15 rotates the housing 3 of the perforating mechanism 2 around the punch housing, preferably at a uniform rate such as 60 revolutions per minute for example. The chuck 10 motors 20 and 24 are controlled to operate the chuck such that the piping 8 is moved relative to the punch housing 4 to perform a pattern of perforations. The hydraulic motor 15 speed can be adjusted, for example it can be reduced for low density perforation patterns where the piping 8 movements between perforations by the mechanism 2 are relatively large.

The central aperture 103 of the punch housing through which the piping is rotatably and longitudinally moveable, may have a plurality of arcuate grooves to minimise friction on the piping 8 therein. Further, the central aperture 103 may be double-flared with radiused outer edges to enhance movement of the piping 8 therethrough. The configuration is preferably such that the longitudinal and rotational movement of the piping are not constrained to one another by engagement of the piping in the aperture 103. That is, the piping is independently or freely longitudinally and rotationally moveable through the aperture.

As shown in FIG. 4b, each punch 7 comprises a punch holder to removably hold the punch member 7a. The punch holder comprises a main body portion 70. Each main body portion 70 defines a T-slot 72 at one end thereof. Each punch holder further includes an insert 74 with a tubular body and an enlarged head, the head being sized such that it may be removably mounted in the T-slot of the main body portion 70. The aperture in the centre of the insert 74 has an enlarged region at its upper (radially outward) end in order to hold a punch member 7a therein. The punch member 7a projects from a lower (radially inward) end of the insert, to enable the projecting end 7a′ to perforate the piping 8.

The main body portion 70 of each punch holder is slidable within a respective radial aperture 101 of the punch housing, but does not directly engage the walls of the aperture. Rather, the main body portion 70 is slidably mounted in an actuator 82 of a clamping mechanism 80 associated with the punch, which itself is slidable within the aperture 101 of the punch housing. The clamping mechanism will be described in detail below. Annular recesses 70a are provided in the exterior of the main body portion 70 for receipt of bearing members to enable the main body portion 70 to slide relative to its respective clamping mechanism actuator 82.

The opposite (radially outward) end of the main body portion 70 comprises an engagement surface 76 that is angled such that a leading portion 76a of the engagement surface that is initially engaged by a roller 6 as the annular housing 3 rotates relative to the punch housing 4 is positioned at a first radial distance from the aperture 150, and a trailing portion 76b of the engagement surface that is subsequently engaged by a roller is positioned at a second radial distance from the aperture 150, wherein the second radial distance is greater than the first radial distance. That causes the punch to gradually engage the piping during a perforating step.

Rather than using multi-part punches, the punches could be unitary items. However, the multi-part configuration is preferred, as it means only the punch members 7a themselves need to be removed and replaced when they become worn, rather than the entire punches. To remove and replace the punch members 7a, the inserts 74 can be removed from the main body portions 70 by sliding them laterally out of the slot 72 (in the direction through the depth of the page in FIG. 4b). The punch members 7a can then be removed from the inserts, new punch members placed in the inserts, and the inserts re-engaged with the main body portions 70. FIG. 3a shows the punches with the inserts and punch members removed. An additional advantage of using the punch holder rather than unitary punches is that standard off-the-shelf punch members may be used in the perforating machine, resulting in lower costs.

Inserts 74 having different inner diameters may be used, to allow the use of different diameter punches. For example, in the machine it may be desirable to use four punches of one diameter alternating with four punches of a larger diameter, so that each alternate hole punched in the tube is larger than its neighbouring hole. Other combinations could be provided.

The pin 17 from the main body portion 70 of the punch extends through an aperture in the main punch holder body portion 70 and through radial elongate slots 4b in the punch housing body 4. The small wheels or rollers 19 interact with the channel 5 of the annular housing 3 as described above.

The apparatus has a mandrel 300 with an arbor and die for supporting the piping from inside during punching, at least in the region being perforated 8. FIG. 17 shows one suitable form, but other forms could be used. The mandrel has an arbor 302 and a die 308. The arbor 300 has a portion of reduced diameter 303 at one end thereof which may extend through an arbor support of the machine and be clamped in a clamping block. The arbor 300 will extend through the chuck 10 and the piping 8 when the piping is gripped by the chuck 10.

Attached to the other end of the arbor 302 is a die 308 which supports the piping during punching. The die 308 is held in position on the arbor 300 by a threaded engagement 320. A fastening means such as a fixing cap screw (not shown) extends through an aperture 321 in the die into contact with the arbor, and maintains the die 308 in position on the arbor 302.

As can be seen from FIG. 18, the die 308 includes a plurality of radial apertures 312. The apertures are provided in annular bands, and the number and orientation of the apertures 312 in each annular band preferably corresponds to the number and orientation of the radial apertures 101 in the punch housing and, accordingly, the number and orientation of the punches 7. When the apertures in the die wear, the die can be moved so another band of apertures is aligned with the punches of the punch housing.

In use, when the piping 8 is being punched, the punch members extend through the piping 8 and into the apertures 312 in the die 308. The outer surface of the die 308 supports the inside of the piping during punching. The clamping mechanisms described below push the piping against the outer surface of the die 308 during punching, or hold the piping against the outer surface of the die if the particular part of the piping is already contacting the die.

The arbor and die are hollow, and are in fluid communication with a vacuum or blowing source, to remove the punch slugs (waste material) from the die area as these will fall through apertures 312 during punching. This reduces the chances of the punching area or punched tube becoming jammed by slugs. This is particularly advantageous if an automatic pipe loader is to be used, and even more so if one end of the pipe is perforated then the pipe is withdrawn and turned around so the other end can be perforated.

Turning to FIGS. 4a-4d, at least some of the punches have an associated clamping mechanism 80 that is adapted to apply a force to the exterior of the piping 8 adjacent the respective punch during least a major part of the duration of a perforating step by that punch, to push the piping 8 against the mandrel 300 or hold the piping against the mandrel. Preferably, all of the punches have an associated clamping mechanism. However, in an alternative embodiment there may be more punches than there are clamping mechanisms. For example, every second punch may have an associated clamping mechanism. It is preferred that at least four clamping mechanisms are provided, with the mechanisms being provided as two pairs, wherein one clamping mechanism in a pair is substantially diametrically opposed to the other clamping mechanism in the pair.

As shown in FIG. 4b, each clamping mechanism has a tubular clamping mechanism actuator 82. The clamping mechanism actuator 82 surrounds the main body portion 70 of the punch, and the main body portion is slidable within the clamping mechanism as described above. The clamping mechanism further comprises a clamping portion 84 having an enlarged end 84a that is positioned adjacent the actuator 82, and a reduced cross-section tubular portion 84b that extends downwardly therefrom. The punch insert 74 is slidable within the tubular portion 84b. The lower (radially inward) end of the clamping portion defines a clamping surface 84c. The clamping surface 84c applies a force against the exterior of the piping adjacent the respective punch.

The clamping mechanism could be an integral member rather than multi-piece. As shown in FIG. 3a, a retainer 85, which in the form shown is a cap screw is fastened to a side wall of the clamping mechanism actuator 82, and projects into an enlarged aperture 4c in the punch housing 4. This retainer maintains the clamping mechanism in position in the punch housing, but the enlarged aperture provides the necessary radial travel of the clamping mechanism.

Each clamping mechanism is provided with a clamp retracting mechanism. In the form shown, the clamp retracting mechanism has one or more biasing members, which in the form shown, comprises a pair of spring washers 86, that biases the clamping mechanism radially outwardly to the position shown in FIG. 4b. In that position, the clamping surface 84c of the clamping mechanism clears the outer surface of the piping 8, so that the piping is freely movable in the aperture 103. Any other suitable mechanism could be used to cause the clamping mechanism to move to the position shown in FIG. 4b. For example, a different type of spring could be used. As another alternative, an auxiliary channel similar to channel 5 could be provided in the annular housing 3, with rollers or wheels projecting from the clamping mechanism actuator into the auxiliary channel.

The clamping mechanisms are actuated by the rollers in a similar way to the punches. The apparatus is configured such that the clamping mechanisms 80 are actuated by the rollers 6 to apply force to the exterior of the piping 8 as or before the respective punch 7 begins a perforating step and to release force from the exterior of the piping 8 as or after the respective punch 8 completes its perforating step, so that the force is applied by the respective clamping mechanism 80 throughout the duration of the perforating step by the respective punch 7. In the preferred form, the apparatus is configured such that the clamping mechanisms are actuated by the rollers to apply force to the exterior of the piping before the respective punch begins a perforating step and to release force from the exterior of the piping after the respective punch completes its perforating step, so that force is applied by the respective clamping mechanism for longer than the duration of the perforating step by the respective punch.

Each clamping mechanism comprises an engagement surface 83 at the upper (radially outward) end of the clamping mechanism actuator 82. It will be appreciated that as the actuator is tubular, the engagement surface will be annular, as shown in FIG. 4d. The clamping mechanism engagement surface 83 is engaged by the roller 6 to cause the clamping mechanism 80 to apply force to the exterior of the piping 8 prior to the roller 6 engaging the respective punch engagement surface 76 to actuate the respective punch 7. The clamping mechanism engagement surface 83 is disengaged by the roller 6 to cause the clamping mechanism 82 to release force from the exterior of the piping 8 after the rollers 6 disengage the respective punch engagement surface 76 to cease actuating the respective punch 7.

As can be seen in FIG. 4b, each clamping mechanism engagement surface 83 comprises an angled leading surface 83a, wherein an initial portion 83a′ of the angled leading surface that is initially engaged by a roller is positioned at a first radial distance from the aperture 103 of the punch housing 4, and a trailing portion 83a″ of the initial angled leading surface 83a that is subsequently engaged by the roller is positioned at a second radial distance from the aperture 103, wherein the second radial distance is greater than the first radial distance to cause the clamping mechanism to gradually engage the piping 8. Each clamping mechanism engagement surface 83 comprises an angled trailing surface 83b, wherein an initial portion 83b′ of the angled leading surface that is initially engaged by a roller is positioned at a first radial distance from the aperture 150, and a trailing portion 83b″ of the initial angled leading surface 83b that is subsequently engaged by the roller is positioned at a second radial distance from the aperture 150, wherein the second radial distance is less than the first radial distance to cause the clamping mechanism to gradually disengage the piping. The remainder 83c of the clamping mechanism engagement surface 83 that is positioned between the leading surface 83a and the trailing surface 83b, matches the annular curvature of surface 4a.

It can be seen that portions 83a′ and 83b″ sit substantially flush with the adjacent part of annular surface 4a of the punch housing, and the remaining portions of the clamping mechanism engagement surface 83 and the punch engagement surface 76 project radially outwardly beyond the annular surface 4a, when the clamp and punch are not actuated by the roller.

Rather than being a tubular member, the clamping mechanism actuator 82 could be a different configuration. For example, the actuator may be in the form of a single wall positioned to the side of the punch and that incorporates the leading, intermediate, and trailing portions of the engagement surface. However, the tubular form of the actuator is preferred, as it causes the clamping mechanism to apply force more evenly around the punch.

As the housing 3 is rotated around the punch housing 4, the eight rollers 6 roll around the outside of the hub 4 and each simultaneously contacts the protruding head of a punch 7. For the punches that are provided with associated clamping mechanisms, the rollers 6 will initially engage and operate the clamping mechanisms, and will then engage and operate the punches. The channels 5 which rotate with the housing 3 and rollers 6, present a dip 15 at this point to allow the punches 7 to be engaged by the rollers 6 to perforate the piping 8 at (notionally) 0°, 45°, 90°, 135°, 180°, 225°, 270°, and 315°. As the housing 3 rotates further, the rollers 6 lose contact with the punches 7 and then the clamping mechanisms, and the channels 5 present a non-dipped profile which forces the punches 7 out of the piping 8 such that their heads again protrude above the hub 4. The springs 86 force the clamping members out of engagement with the piping. At this point the chuck 10 may either: push the piping to its next longitudinal position and allow perforation at °, 45°, 90°, 135°, 180°, 225°, 270°, and 315°; rotate the piping 8 to allow perforation at other angles separated by 45° at the same longitudinal position; or push and rotate the piping 8 to allow perforations at a different longitudinal position at 0°, 45°, 90°, 135°, 180°, 225°, 270°, and 315° or other angles separated by 45°. This combination of actions allows a wide variety of perforation patterns to be introduced into the piping 8.

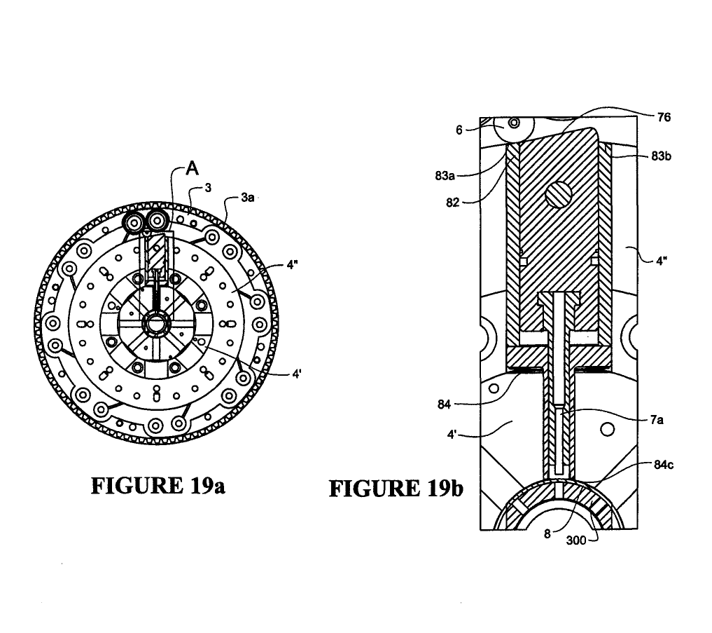

FIGS. 19a, 19b show the clamping mechanism after it has been engaged by the roller 6, and before the roller 6 has actuated the punch 7. It can be seen that the clamping mechanism has been moved radially inwardly, so that clamping surface 84c of the clamping mechanism pushes the piping 8 against the mandrel 300. It will be appreciated that as several clamping mechanisms will be positioned around the piping and they will be actuated concurrently, the force will be applied to the exterior of the piping from several different directions. It can be seen that in this position, the punch member is still clear of the piping 8, as the roller 6 has not yet engaged surface 76 of the punch. For punches that are not provided with clamping mechanisms, member 70 will be slidably mounted directly in a respective aperture 101, and those punches will not yet have been activated by the rollers.

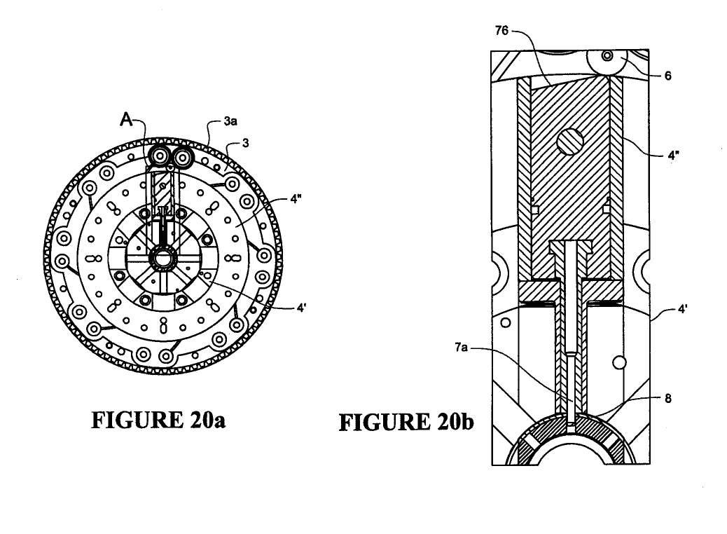

FIGS. 20a, 20b show the clamping mechanism and punch after the annular housing 3 has rotated further around the punch housing 4. In the position shown, the punch has been fully actuated by the roller 6, and is about to be released by the roller. It can be seen that the punch member has perforated the piping 8. The clamp mechanism 80 is still fully depressed by the roller, so that surface 84c is still applying force to the outside of the piping. The punches that do not have associated clamping mechanisms will also have perforated the piping in the same way. Upon further rotation, the punch will be disengaged by the roller and then the clamping mechanism will be disengaged by the roller, so that both the punch and the clamping mechanism will clear the piping, so the piping can be longitudinally and/or rotationally moved relative to the punch housing.

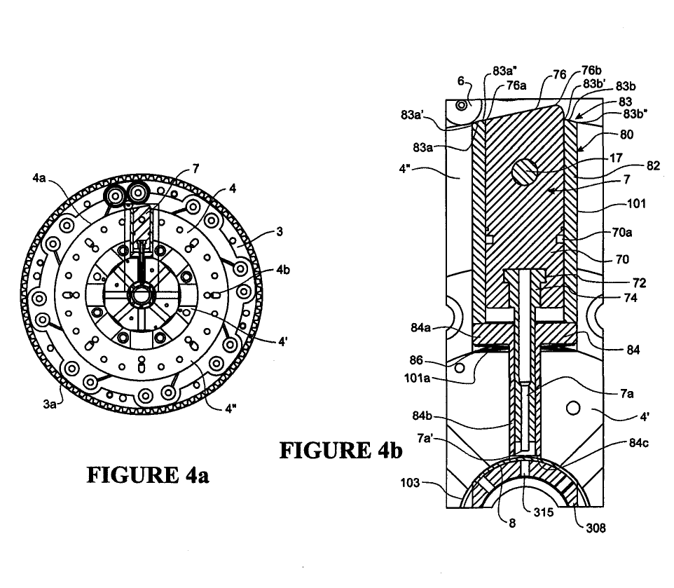

FIG. 5 shows a perforation pattern using eight perforations per longitudinal position which are displaced from the previous and next perforation set by 22½°. To achieve this pattern the chuck 10 secures the piping 8 in a first longitudinal position while the perforating mechanism 2 rotates 90° and performs eight perforations at (notionally) 0°, 45°, 90°, 135°, 180°, 225° and 315°. The chuck 10 then pushes the piping 8 to the next longitudinal position and rotates it by 22½° before securing the piping 8 in this position for a further 90° rotation of the perforating mechanism 2. At the next longitudinal position the chuck 10 may either rotate the piping 8 by a further 22½° or rotate it back to its original rotational position.

Referring to FIG. 1, the preferred form programmable or programmed control system comprises a computer program and a control panel 30 comprising: a computer 33, a screen 31, a keyboard 32, manual controls 34, and a cable connection 35 to the apparatus 1.

The manual controls 34 include start and emergency stop controls, chuck 10 clamp and unclamp controls for securing or releasing the piping 8, and chuck 10 lateral movement controls. The controls 34 allow the operator to load a length of piping into the apparatus 1, prior to initialising perforation; and to remove the perforated piping 8.

The program loaded onto a computer 33 in the control panel 30 allows an operator to select from a wide variety of preset perforation patterns, customise a unique pattern or instruct the program to calculate a pattern automatically according to parameters such as the area of piping to be removed. The motors 15, 20 and 24 of the apparatus 2 are then controlled to perforate the piping 8 according to the selected, customised or automatically generated perforation patterns. Alternatively a simpler controller such as a PLC contained within the apparatus 1 could be used. This could, for example, be used in an apparatus 1 where only one or a limited number of preset perforation patterns are required.

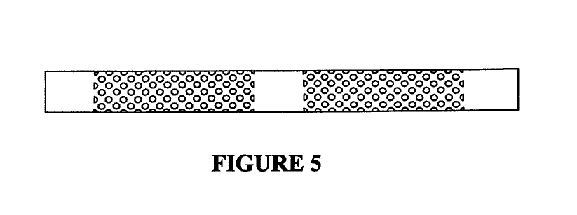

The program is preferably in the form of a menu driven program which allows the operator using the keyboard 32 and screen 31, to either select a perforation pattern from an available range contained in a database, customise a pattern or instruct the program to generate a pattern automatically. FIG. 6 shows a start up screen with, from the top, an options row each generating a popup menu screen (not shown) when selected, a quick options icon row, a piping overview diagram, a perforation pattern diagram, and a working parameters row. The piping overview diagram displays the piping 8 length and one or more zones of perforation or sections of the piping 8. The perforation pattern diagram displays a 90° or quarter section of piping 8 over a particular zone. Each perforation or hole image on the pattern diagram represents four perforations separated by 90° in the piping 8. A pattern for that zone can then either be customised, automatically generated, or copied from another zone on the same piping 8 or from a data base of perforation patterns. Additionally, a pattern drawn from the data base can then be customised. The parameters row can include: the current zone of the perforation pattern diagram; the number of holes in the piping 8 resulting from the current pattern; the area of piping 8 removed by the perforation pattern; the hole size; the piping wall thickness; and other desired working parameters.

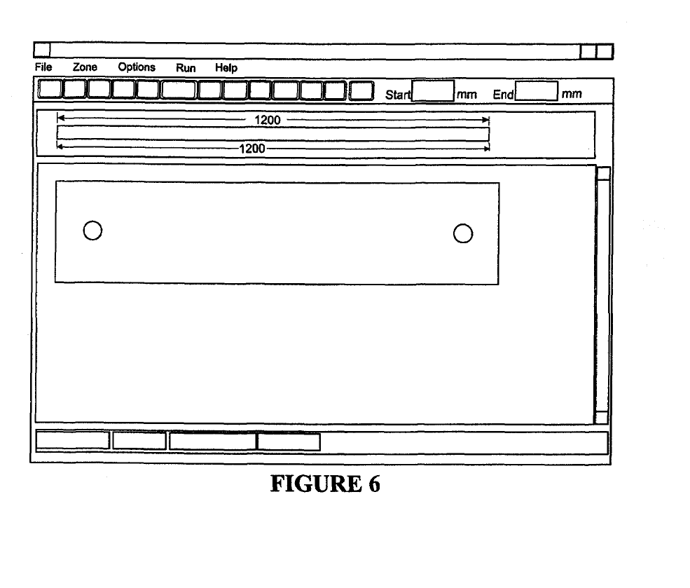

To enter a perforation pattern, the file option is chosen which then displays a popup menu with new or open perforation file options. The open option allows the selection of a perforation pattern from the data base. FIG. 7 shows a selection with a 1200 mm length pipe with two perforation zones at 38 to 600 mm and 800 to 1000 mm (as shown in the piping overview diagram). The perforation pattern diagram shows a spiral perforation pattern in the first zone. The number of zones and each zone's length and pattern can be adjusted using the zone option. When the perforation pattern for the piping is completed, the run option is selected such that the required apparatus 1 motor 15, 20 and 24 movements are calculated and carried out. Once set up, a perforation pattern can be rerun for any number of piping 8.

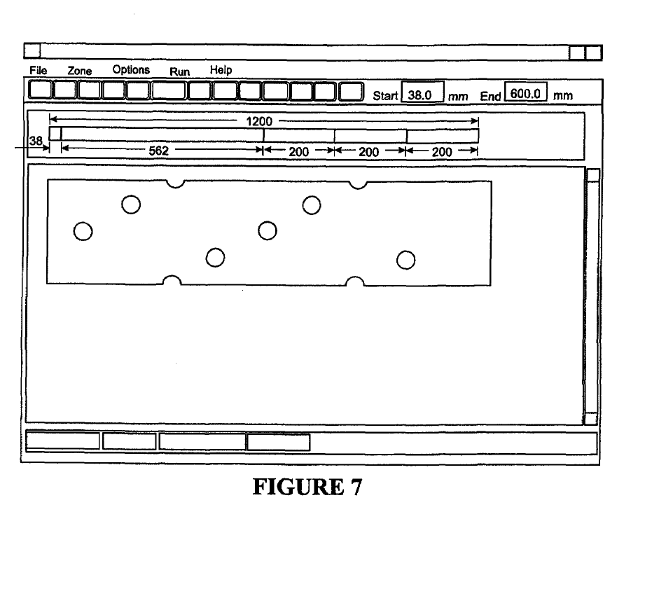

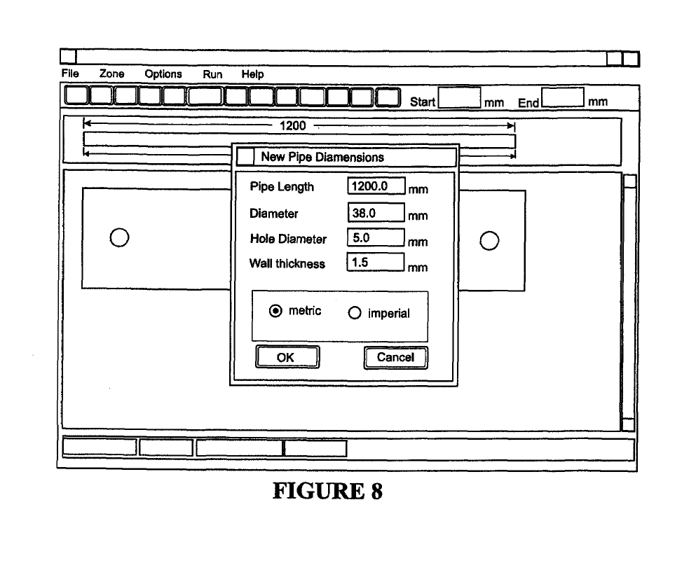

To set up a new or customised pattern, the new menu option from the file option of the startup screen in FIG. 6 is selected, which generates a popup new pipe dimensions screen as shown in FIG. 8. The operator then enters the new pipe length, diameter, hole diameter and/or wall thickness dimensions. The required number and size of zones is entered using the zone option. The current working zone can be selected either with the zone option or with an equivalent icon. A new perforation pattern can then be created for each zone by selecting the perforation icon (rightmost) with a mouse cursor then guiding the resultant hole image on the perforation diagram as shown in FIG. 9. The hole image shows the hole in dashed outline as well as its position relative to a permanent first hole at a notional position of 0° and 0 mm. The hole image can be placed at 0°, −22.5°, +22.5° and +45° and at any longitudinal distance from the first permanent hole in the zone. Each hole image represents eight holes spaced at 45° or a set of perforations around the piping corresponding to the simultaneous engaging of eight punches 7 by the rollers 6 of the perforating mechanism 2 as shown in FIG. 3. By repeating this hole image or set placement procedure a customised perforation pattern can be built up which when completed can be copied to another zone, stored in the data base and/or run and performed on piping 8 loaded in the apparatus 1. A pattern retrieved from the data base can also be modified using the customising procedure outlined above.

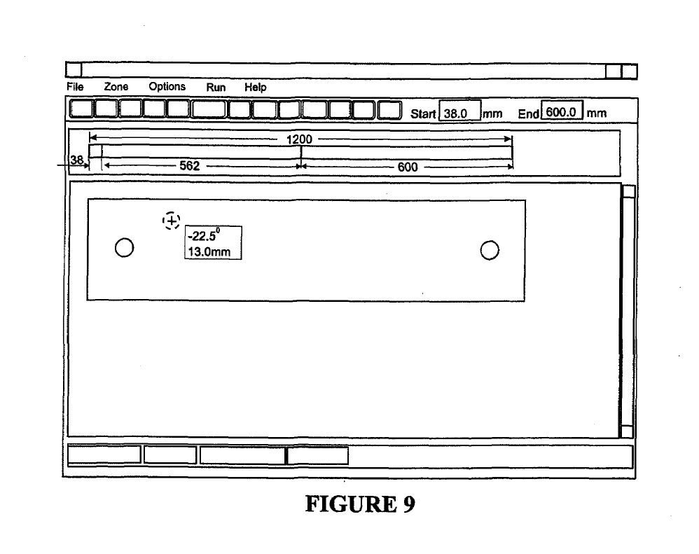

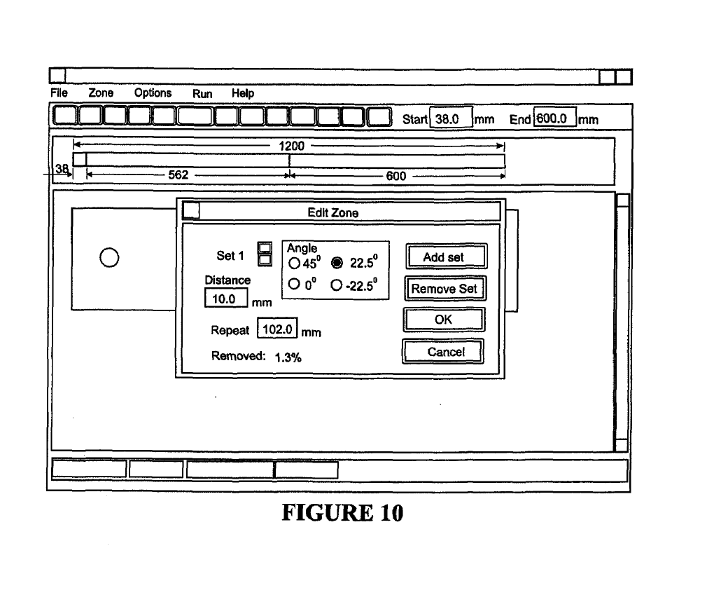

Alternatively the zone edit menu options can be used to add or remove sets of perforations or holes as shown in FIG. 10. If one or more sets have been previously added, these can be removed by selecting the angle and distance with respect to the permanent first set and the remove set icon. To add a new set, the add set icon is selected which generates the popup screen shown in FIG. 11. The new set's angle (0°, −22.5°, +22.5° or +45°) and distance with respect to the permanent first set can then be entered. The edited zone pattern is then displayed on the perforation pattern diagram.

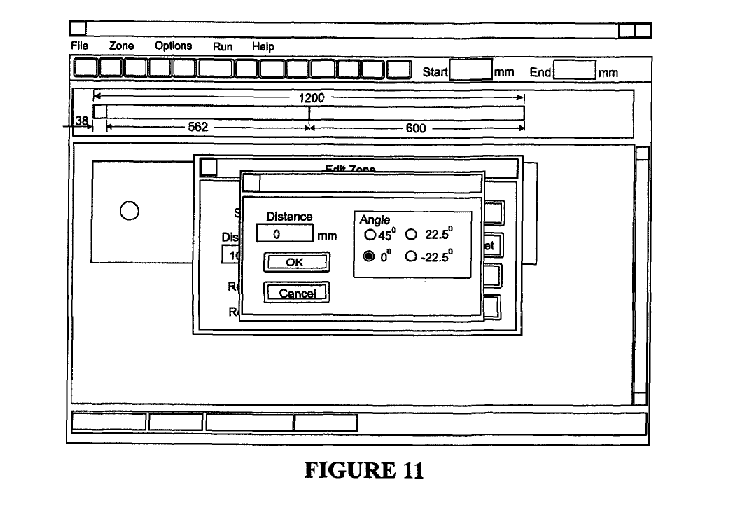

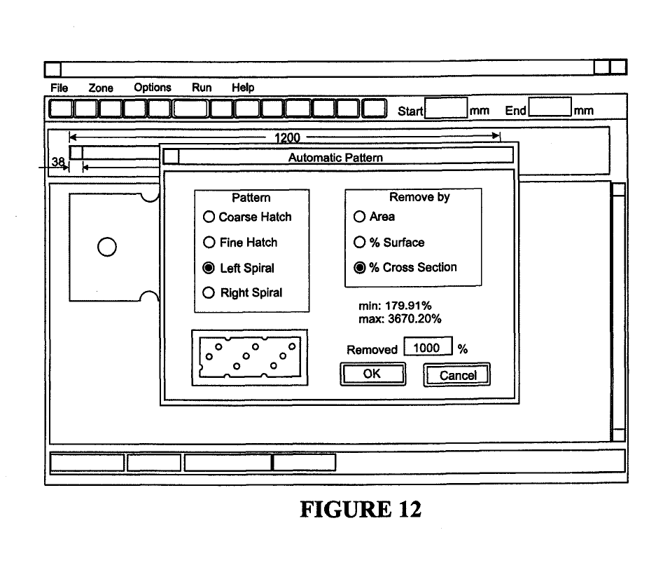

The program can be used to automatically calculate a pattern for a zone using the zone automatic menu options. Course or fine hatch, left or right spiral patterns can then be selected as shown in FIG. 12. The amount of piping to be removed by the perforation pattern can be selected by actual surface area, percentage of piping surface area, or by percentage of the cross sectional area of the piping. Maximum and minimum possible values are generated by the program according to parameters including the zone size, perforation size, number of punches and pattern type. FIG. 13 shows an automatically generated left spiral pattern with 1000% of the piping's cross sectional area removed, for a zone length of 562 mm, a piping diameter of 38 mm, a hole diameter of 5 mm and a piping wall thickness of 1.5 mm. Other pattern types or parameters could also be used to automatically generate a pattern. Once completed, the automatically generated perforation pattern can be copied to another zone or to the database.

It will be appreciated that the control system is configured to control and coordinate the longitudinal and rotational movement of the piping through the punch housing with the operation of the clamping mechanisms and punches, to cause the apparatus to support the piping and then perforate a predetermined, selected part or parts of the piping, with the programmed, selected arrangement or pattern of perforations. Preferably, the pattern that the control system is programmed or programmable with includes at least one variation in perforation arrangement, and the control system is configured to cause the apparatus to cause the apparatus to perforate the piping with the programmed, selected pattern of perforations, including said at least one variation in perforation arrangement. That is, the control system is preferably configured to form multiple zones of perforations in the piping. Preferably, the control system is configured to punch at least five zones in the piping, with each zone optionally having a different perforation pattern from the other zones.

The preferred embodiment perforation apparatus described above enable perforation patterns to be easily selected and rapidly applied to piping or tubing. By utilising the clamping mechanisms, the positioning of the piping relative to the mandrel and punches is kept very accurate throughout the perforating steps, thereby reducing wear on the equipment.

The foregoing describes the invention including a preferred form thereof. Alterations and modifications as will be obvious to those skilled in the art are intended to be incorporated within the scope hereof.

1. A perforation apparatus suitable for perforating tubing or piping comprising:
a mandrel adapted to support at least a part of the piping that is to be perforated, wherein the mandrel is adapted to support the piping from the interior of the piping;
a punch housing comprising an aperture through which the piping is longitudinally and rotationally moveable and a plurality of punches arranged radially around the aperture and operable to perforate the piping passing through the punch housing, with the punches adapted to perforate the piping by passing from an exterior of the piping to an interior of the piping, wherein at least some of the punches have an associated clamping mechanism that is adapted to apply a force to the exterior of the piping adjacent the respective punch during least a major part of the duration of a perforating step by that punch, to push or hold the piping against the mandrel;
a driven annular housing comprising an aperture corresponding to the punch housing aperture and arranged to rotate adjacent the punch housing, a plurality of rollers arranged to rotate in an annular path around the punch housing upon rotation of the annular housing and arranged to engage a surface on the punches during rotation of the annular housing to operate the punches upon contact and to operate the clamping mechanisms, and a punch retracting mechanism arranged to retract the punches after each operation; and
at least one mechanism to longitudinally and rotationally move the piping relative to the punch housing and to drive the annular housing.

2. A perforation apparatus as claimed in claim 1, wherein the apparatus is configured such that the clamping mechanisms are operated by the rollers to apply force to the exterior of the piping as or before the respective punch begins a perforating step and to release force from the exterior of the piping as or after the respective punch completes its perforating step, so that the force is applied by the respective clamping mechanism throughout the duration of the perforating step by the respective punch.

3. A perforation apparatus as claimed in claim 2, wherein the apparatus is configured such that the clamping mechanisms are operated by the rollers to apply force to the exterior of the piping before the respective punch begins a perforating step and to release force from the exterior of the piping after the respective punch completes its perforating step, so that force is applied by the respective clamping mechanism for longer than the duration of the perforating step by the respective punch.

4. A perforation apparatus as claimed in claim 3, wherein the clamping mechanisms each comprise an engagement surface and the punches each comprise an engagement surface, wherein the clamping mechanism engagement surfaces are engaged by the rollers to cause the clamping mechanisms to apply force to the exterior of the piping prior to the rollers engaging the respective punch engagement surfaces to operate the respective punches, and wherein the clamping mechanism engagement surfaces are disengaged by the rollers to cause the clamping mechanisms to release force from the exterior of the piping after the rollers disengage the respective punch surfaces to cease operating the respective punches.

5. A perforation apparatus as claimed in claim 4, wherein each clamping mechanism engagement surface comprises an angled leading surface, wherein an initial portion of the angled leading surface that is initially engaged by a roller is positioned at a first radial distance from the aperture of the punch housing, and a trailing portion of the initial angled leading surface that is subsequently engaged by the roller is positioned at a second radial distance from the aperture of the punch housing, wherein the second radial distance is greater than the first radial distance to cause the clamping mechanism to gradually engage the piping.

6. A perforation apparatus as claimed in claim 1, wherein a plurality of pairs of adjacent rollers are rotatably mounted to the driven annular housing, and a respective auxiliary roller is captured between each pair of rollers and an annular surface on the punch housing, with the auxiliary rollers caused to move in an annular path around the annular surface of the punch housing to engage the clamping mechanisms and the punches.

7. A perforation apparatus as claimed in claim 6, wherein the clamping mechanism engagement surfaces and the punch engagement surfaces at least partly project from the annular housing for engagement by the rollers.

8. A perforation apparatus as claimed in claim 1, wherein the punches each comprise a punch holder with a respective punch member.

9. A perforation apparatus as claimed in claim 8, wherein the punch holders each comprise a main body portion that removably supports the punch members, and the main body portion defines a punch engagement surface which cooperates with the rollers to actuate the punch.

10. A perforation apparatus as claimed in claim 9, wherein the punch holders each comprise a removable insert that is removably engaged with the main body portion, with the punch member receivable in the insert.

11. A perforation apparatus as claimed in claim 1, wherein each punch comprises an engagement surface that is angled such that a leading portion of the engagement surface that is initially engaged by a roller is positioned at a first radial distance from the aperture of the punch housing, and a trailing portion of the engagement surface that is subsequently engaged by a roller is positioned at a second radial distance from the aperture of the punch housing, wherein the second radial distance is greater than the first radial distance to cause the punch to gradually engage the piping during a perforating step.

12. A perforation apparatus as claimed in claim 1, wherein each punch has an associated clamping mechanism.

13. A perforation apparatus as claimed in claim 1, wherein some punches have an associated clamping mechanism and some punches do not have an associated clamping mechanism.

14. A perforation apparatus as claimed in claim 1, comprising four punches with associated clamping mechanisms arranged radially around the aperture, wherein the clamping mechanisms of the four punches are configured to apply force to the piping concurrently.

15. A perforation apparatus as claimed in claim 14, wherein said four punches with associated clamping mechanisms are arranged at a substantially even angular spacing around the aperture.

16. A perforation apparatus as claimed in claim 14, comprising more than four punches with associated clamping mechanisms arranged radially around the aperture.

17. A perforation apparatus as claimed in claim 12, wherein the punch housing comprises eight punches at about 45° angular spacing.

18. A perforation apparatus as claimed in claim 1, comprising a control system that is programmed or programmable with a selected arrangement or pattern of perforations and that is configured to control and coordinate the longitudinal and rotational movement of the piping through the punch housing with the operation of the clamping mechanisms and punches, to cause the apparatus to perforate a predetermined, selected part or parts of the piping, with the programmed, selected arrangement or pattern of perforations.

19. A perforation apparatus as claimed in claim 18, wherein the pattern that the control system is programmed or programmable with comprises at least one variation in perforation arrangement, and the control system is configured to cause the apparatus to perforate the piping with the programmed, selected arrangement or pattern of perforations, including said at least one variation in perforation arrangement.

20. A perforation apparatus as claimed in claim 18, wherein the control system is configured to control a punch actuation motor, a longitudinal piping movement motor and a rotational piping movement motor.

21. A perforation apparatus as claimed in claim 18, wherein the control system enables an operator to select from a preset perforation pattern, customise a unique pattern or instruct the system to calculate a pattern automatically.

22. A perforation apparatus as claimed in claim 18, wherein the control system enables an operator to select from a preset perforation pattern, and comprises a programmable logic controller (PLC).

23. A perforation apparatus as claimed in claim 1, wherein the mechanism to move the piping relative to the punch housing comprises a chuck arranged to selectively grip the piping.

24. A method of perforating piping using an apparatus as claimed in claim 1, the method comprising:
operating the clamping mechanisms to apply a force to the exterior of piping extending into or through the punch housing to push the piping against the mandrel;
operating the punches to perforate the piping; and
releasing the clamping mechanisms.

25. A method as claimed in claim 24, further comprising following releasing the clamping mechanisms, longitudinally and/or rotationally moving the piping relative to the punch housing, and:
operating the clamping mechanisms to apply a force to the exterior of piping extending into or through the punch housing to push the piping against the mandrel;
operating the punches to perforate the piping; and
releasing the clamping mechanisms.
